(19) United States
(12) Patent Application Publication
(10) Pub. No.: US 2012/0036042 A1
(43) Pub. Date: Feb. 9, 2012

(54) SYSTEM AND METHOD FOR CHECKOUT AND CUSTOMER DATA CAPTURE IN COMMERCE APPLICATIONS

(75) Inventors: Will Graylin, Saugus, MA (US); Michael Arner, Brighton, MA (US); Jimmy Tai Kwan Tang, Hong Kong (HK)

(73) Assignee: ROAM DATA INC, Boston, MA (US)

(21) Appl. No.: 13/080,047

(22) Filed: Apr. 5, 2011

Related U.S. Application Data
(63) Continuation-in-part of application No. 12/850,685, filed on Aug. 5, 2010.

(51) Int. Cl. G06Q 30/00

(52) U.S. Cl. 705/26.41

(57) ABSTRACT

A commerce checkout and customer data capture system for merchants to deliver commerce functionalities to consumer computing devices for completing purchase and payment transactions includes a commerce application and a commerce gateway server comprising a checkout application and a secure payment application. A plurality of merchants are configured to provide product offers to the consumer computing device via the commerce application, to process purchase transactions with the checkout application, and to receive payments via the secure payment application. The checkout application provides responses to purchase transaction requests including “CreateCheckout” for setting up and capturing purchase transaction data, and consumer related data, “Checkout” for calling a checkout transaction user interface, and “GetCheckoutStatus” for checking status of a checkout transaction. The checkout application further captures additional data used to provide fulfillment capabilities, tax calculation, risk management, fraud control, and targeted marketing analytics.

### CROSS REFERENCE TO RELATED CO-PENDING APPLICATIONS

This application is a continuation in part of U.S. application Ser. No. 12/850,685 filed on Aug. 5, 2010 and entitled SYSTEM AND METHOD FOR A COMMERCE WINDOW APPLICATION FOR COMPUTING DEVICES which is commonly assigned and the contents of which are expressly incorporated herein by reference.

### FIELD OF THE INVENTION

The present invention relates to a system and a method for checkout and customer data capture in commerce applications, and more particularly to checkout and customer data capture in commerce applications that deliver purchase transaction checkout functionalities to consumer computing devices.

### BACKGROUND OF THE INVENTION

Traditional e-commerce payment processing applications and application programming interfaces (APIs) rely on merchants to take care of the shopping cart, checkout, and customer fulfillment data capture functions on their own commerce websites or applications. The merchants handle all of the level 3 credit card processing parameters including product information, shipping information, and tax calculations, among others, and then pass the payment off to a payment-provider, such as Authorize.Net or PayPal to handle the payments on their behalf. This means that the payment-providers only require certain parameters in their APIs, such as merchant information, amount to be paid, and some description of the purchase, as they only handle payments. Therefore the payment-provider's API does not request other information that may otherwise be important in a mobile environment for efficient mobile checkout and that may be useful to the merchant.

In the mobile environment, it is critical to reduce the number of steps and the amount of information that a user has to enter to complete a transaction. Further in the mobile environment, additional data sent to the payment-providers can be used to help reduce the risk of fraud for the merchant. Furthermore, consumer data that are captured across different merchants may also allow individual merchants to have more rich data for their customers to not only manage risk, but also provide offers to these customers in the future.

Payment-providers, such as PayPal or Cybersource, extend their current e-Commerce checkout methods to mobile computing environments by providing a library of functions that make it easier for mobile application developers to incorporate the same e-Commerce checkout methods into their mobile applications. However, the checkout methods still capture only payment related information and process the payment.

Accordingly, there is a need for a more efficient checkout process designed for mobile and other computing devices that reduces the number of steps and information that a consumer has to enter to complete a transaction. Furthermore, there is a need for a checkout process designed for the mobile computing environment that captures parameters that reduce the risk of fraud for the merchants, and also allows merchants to have richer data about their customers (including demographics, buying patterns, and loyalty), in order to provide offers to their customers in the future.

### SUMMARY OF THE INVENTION

The present invention provides a checkout API and a checkout application that captures, stores, and presents certain crucial data that are not captured, stored, or presented by prior art payment systems. The captured data are used for product fulfillment, CRM, and fraud prevention management. The capture of these certain data results in shortened checkout process for consumers, enhanced security capabilities, and more valuable consumer data provided to merchants. The invention achieves a more efficient checkout and customer fulfillment process designed for commerce in the mobile environment or commerce on other computing devices by capturing more functionalities and data for the checkout process and providing more data about a given consumer than otherwise would be achieved by each merchant individually.

In general, in one aspect the invention features a commerce checkout and customer data capture system for merchants to deliver commerce functionalities to consumer computing devices for completing purchase and payment transactions. The system includes a commerce application and a commerce gateway server comprising a checkout application, and a secure payment application. The commerce gateway server communicates with a consumer computing device via a network connection. A plurality of merchants are configured to provide product offers to the consumer computing device via the commerce application, to process purchase transactions with the checkout application, and to receive payments via the secure payment application. The checkout application provides responses to purchase transaction requests including “CreateCheckout” for setting up and capturing purchase transaction data and consumer relevant data, “Checkout” for calling a checkout transaction user interface, and “GetCheckoutStatus” for checking status of a checkout transaction. The checkout application further captures additional data used to provide fulfillment capabilities, tax calculation, risk management, fraud control, and targeted marketing analytics.

Implementations of this aspect of the invention may include one or more of the following features. The commerce application may be a native application running on the consumer computing device, a browser based application running on the consumer computing device, or a browser based application running on a merchant server or the commerce gateway server. The secure payment application includes e-wallets for consumers. These e-wallets store payment instrument data, fulfillment data, demographics, loyalty information, and transaction history for the consumers. The checkout application includes a means for prefilling checkout forms with the e-wallet data. The consumer fulfillment data may be shipping address, billing address, email address, phone number, or loyalty relevant information. The commerce gateway server communicates with the consumer computing device via a checkout application programming interface (API) and the checkout API may be a web service or a library object. The “CreateCheckout” request sets up and collects purchase transaction data comprising level 3 credit card processing data. The “CreateCheckout” request sets up and collects purchase transaction data including transaction amount, date, tax amount, customer identifier, merchant identifier, merchant security token, merchant postal code, tax identification, merchant state code, ship from postal code, destination postal code, invoice number, order number, item product identifier, item description, item commodity code, item quantity, item unit of measure, freight amount, and duty amount. The “CreateCheckout” request sets up and collects purchase transaction data comprising consumer computing device location. The consumer computing device location is determined via a global positioning system (GPS), an Internet Protocol (IP) address, or triangulation. The “CreateCheckout” request sets up and collects purchase transaction data comprising at least one of consumer computing device type, phone number, device identifier, international mobile equipment identity (IMEI), network service subscriber identifier, or international mobile subscriber identity (IMSI). The “CreateCheckout” request sets up and collects purchase transaction data including data for calculating tax based on address postal code. The “CreateCheckout” request sets up and collects purchase transaction data comprising consumer risk level data. The checkout application sends the consumer risk level data to the merchants. The purchase transaction data comprise merchant and application identification data. The merchant identification data comprise a merchant identifier and a merchant security token and the application identification data comprise an application identifier and an application security token. The purchase transaction data comprise transaction flow control parameters and the transaction flow control parameters comprise one of merchant CallbackUrl, merchant ReturnUrl, or merchant CancelUrl. The checkout application responds to the “CreateCheckout” request by sending a transaction identifier and the transaction identifier is used in all subsequent checkout operations. The “Checkout” request directs the checkout application to carry out a purchase transaction identified by a specific transaction identifier. The “GetCheckoutStatus” request directs the checkout application to provide checkout status information for a purchase transaction identified by a specific transaction identifier, to display the checkout status information in the consumer computing device, and to provide consumer risk level data and fulfillment data back to the merchant. The consumer computing device may be a mobile phone, personal digital assistant (PDA), payment module, portable computer, personal computer, set-top box, netbook, tablets, iPad, electronic reader, or an Internet appliance.

In general, in another aspect, the invention features a method for merchants to deliver commerce functionalities to consumer computing devices for completing purchase and payment transactions. The method includes providing a commerce application and then providing a commerce gateway server comprising a checkout application and a secure payment application. The commerce gateway server communicates with a consumer computing device via a network connection. A plurality of merchants provide product offers to the consumer computing device via the commerce application, process purchase transactions with the checkout application, and receive payments via the secure payment application. The checkout application provides responses to purchase transaction requests comprising “CreateCheckout” for setting up and capturing purchase transaction data, and consumer related data, “Checkout” for calling a checkout transaction user interface, and “GetCheckoutStatus” for checking status of a checkout transaction. The checkout application further captures additional data used to provide fulfillment capabilities, tax calculation, risk management, fraud control, and targeted marketing analytics.

Among the advantages of this invention may be one or more of the following. The invention includes a checkout API that captures from the merchant application or commerce site additional information, such as product information, product parameters (size, color, quantity, among others), shipping costs, whether tax calculations is required, and shipping information, among others. The checkout API allows less data entry on the consumer side, especially if the consumer has stored their payment information, email, billing & shipping address inside an electronic wallet, so that tax can be calculated based on the stored shipping information. Further, the checkout API captures the location information of the user, risk information that the merchant may see based on their application and that can help reduce fraud and add value to the merchant. Further, the checkout API passes information back to the merchant that a standard payment checkout API may not pass such as customer shipping data, email data, and potential risk assessment data for a consumer/or wallet users that may be fraudulent such that they can take action on the merchant side to disable a subscription to a service or usage of their products and services. There may be data collected about a particular customer or wallet user that one single merchant cannot detect, but are detected through analytics with the data captured via the checkout API.

### BRIEF DESCRIPTION OF THE DRAWINGS

FIG. 1A is an overview diagram of the commerce checkout and data capture system;

FIG. 1B is an overview diagram of another embodiment of the commerce checkout and data capture system;

FIG. 1C is an overview diagram of another embodiment of the commerce checkout and data capture system;

FIG. 2 is a block diagram of the mobile phone applications;

FIG. 3 is a process diagram of the checkout transaction with the commerce checkout system of FIG. 1A-FIG. 1C;

FIG. 4 depicts a screenshot for confirming the purchase of two products with the commerce checkout system of FIG. 1A-FIG. 1C;

FIG. 5 depicts a screenshot of the checkout interface in the commerce checkout system of FIG. 1A-FIG. 1C;

FIG. 6 depicts a screenshot of the payment confirmation in the commerce checkout system of FIG. 1A-FIG. 1C;

FIG. 7 is a flow diagram of the checkout process with the commerce checkout system of FIG. 1A-FIG. 1C and with a stored e-wallet; and

FIG. 8 is a flow diagram of the checkout process with the commerce checkout system of FIG. 1A-FIG. 1C for a new account.

### DETAILED DESCRIPTION OF THE INVENTION

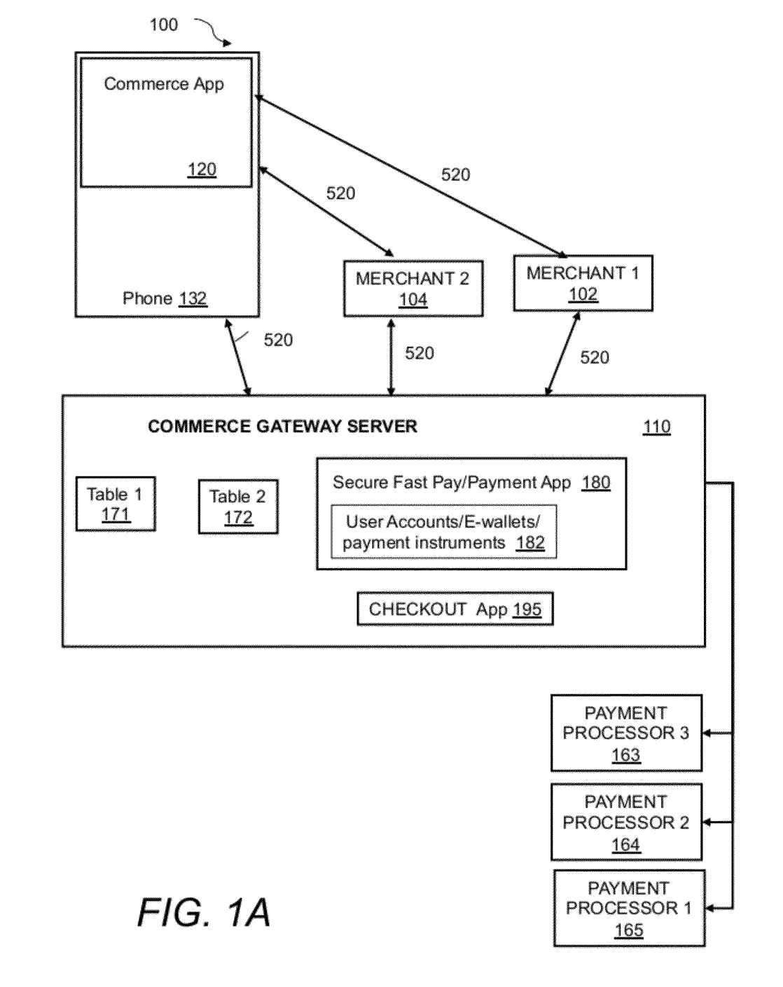

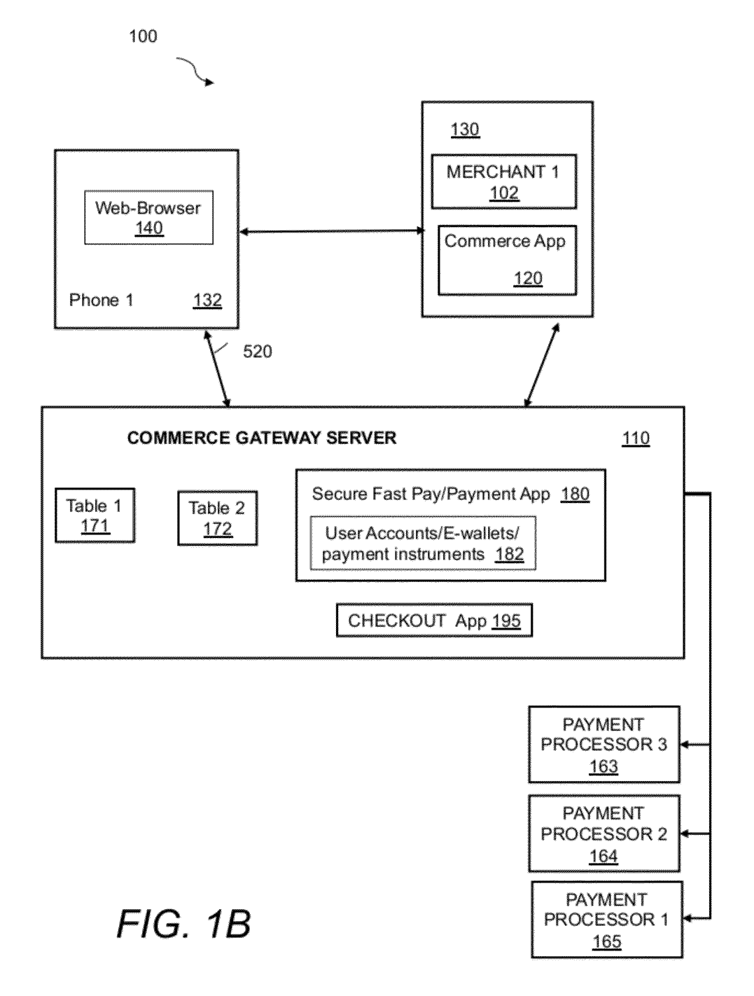

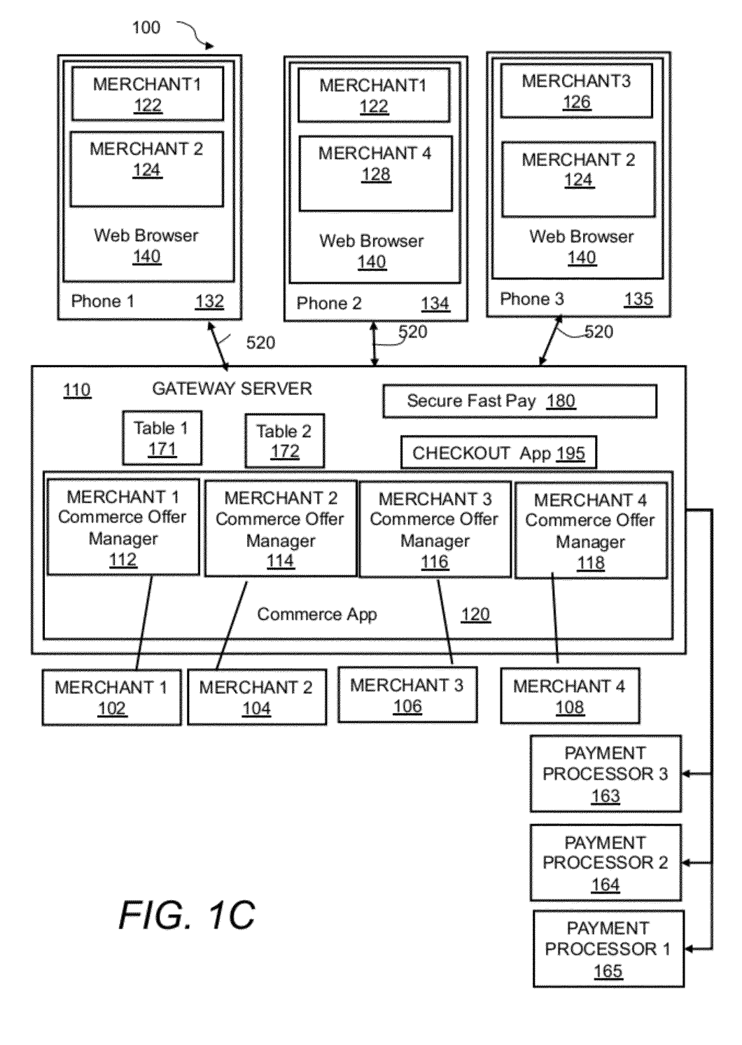

Referring to FIG. 1A, a commerce system 100 for providing commerce functionalities to mobile devices includes mobile phone 132 that interacts with a commerce gateway server 110 via network connection 520. The commerce gateway server 110 includes a checkout application 195 and a secure payment application (“Secure Fastpay”) 180. The mobile phone 132 includes a commerce application 120 and interacts with merchants 102 and 104 via network connections 520. Merchants 102, 104 also interact with the commerce gateway server via network connections 520. In one example, network connection 520 is the Internet. Merchants 102, 104 present product offers to a consumer on the mobile phone 132 via the commerce application 120. In the embodiment of FIG. 1A, commerce application 120 is a native application that runs on the mobile phone 132. In other embodiments, commerce application 120 is a browser based application running through a web browser 140 on the mobile phone 132. In the embodiment of FIG. 1B, commerce application 120 is a browser based application running on the merchant server 130. In the embodiment of FIG. 1C, commerce application 120 is a browser based application running on the commerce gateway server. In this embodiment merchants 102, 104, 106 and 108 provide product offers to mobile phones 132, 134, 135 via commerce application 120. The presentation of product offerings is managed by commerce offer managers 112, 114, 116 and 118, respectively. In the example of FIG. 1C the user of phone 1 selected to display storefronts 122, 124, of merchants 1 and 2, respectively. The user of phone 2 selected to have storefronts 122, 128 of merchants 1 and 4, respectively. Similarly, the user of phone 3 selected to have storefronts 126, 124 of merchants 3 and 2, respectively.

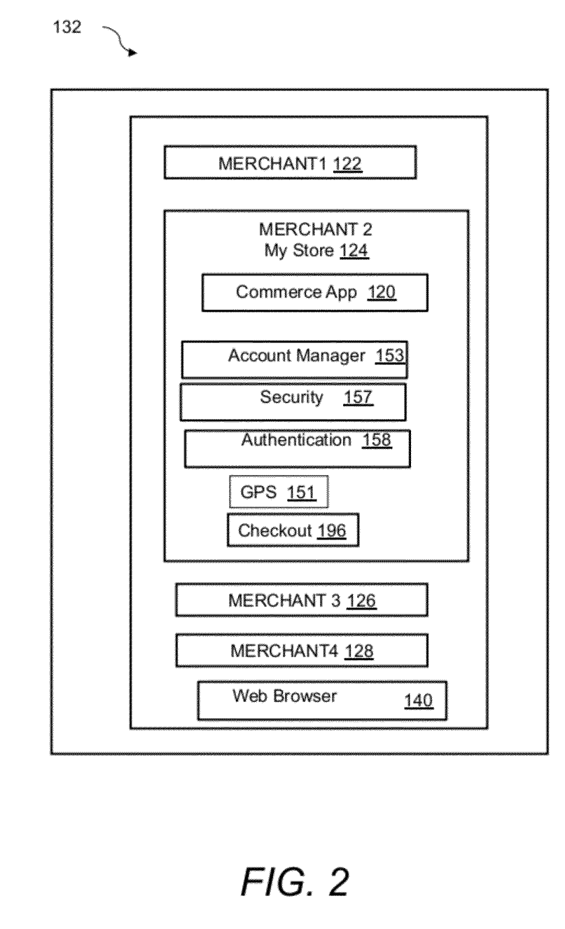

Mobile devices 132, 134, 135 may be any type or format of a mobile device utilizing any type of operating system. Referring to FIG. 2, mobile phone 132 includes in addition to commerce application 120, and web browser 140, an account manager 153, security 157, and authentication 158 data. The account manager 153 manages the details of the account information, such as name, address, shipping information and payment instruments, among others. The authentication data 158 include user name and password, or authentication tokens, or voice or other biometric authentication data. Mobile phone 132 may also include a GPS sensor for providing location information to the commerce gateway server 110. This is an exemplary diagram and therefore the system 100 may include less or more than three mobile devices and less or more than four merchants. Mobile phones 132, 134, 135 belong to consumers that use the devices to perform purchase and payment transactions. The mobile devices 132, 134, 135 may be mobile phones, PC, set top boxes, Net Books, Kindle, and other Internet appliances. The commerce gateway server 110 also connects to payment processors 163, 164, 165 that process payments for the products offered and purchased through the commerce window system 100.

Commerce gateway server 110 is a gateway server, which provides functionality and support of the commerce application 120. In some embodiments, commerce gateway server 110 also delivers product offers to remote terminals 132, 134, 135 and manages these product offers, including the association of the offer with a given product offer ID with a merchant's ID (MID), and to which consumer/user or device (device ID) such an offer goes to. This association of the product ID with the merchant ID and the device ID is stored in Table 1 171, shown in FIG. 1C. Table 1 also stores all merchant IDs, device IDs and product IDs. The MID is also associated with a given payment processor 163, 164, 165. Each payment processor may process different payment instruments and its main job is to authorize payment and deposit funds to the merchant's account if the payment instrument used is valid and has sufficient funds. Table 2 162 stores the payment data information and their associations with the merchant IDs. If the consumer completes the payment transaction via the commerce gateway server, order information, total amount, and payment information are collected by the checkout application 195. Payment information is taken directly from the consumer (i.e. credit card information) each time he/she transacts (“normal pay”). The consumer may also register for “Secure Fastpay” 180, which allows previously used payment instruments to be stored in user accounts or e-wallets 182, and then to be used again quickly with an authentication by the user, as shown in FIG. 1A, FIG. 1B. The payment instrument may be credit cards, prepaid debit cards, PayPal accounts, ACH, among others. The user authentication may be performed via a username and password. In other embodiments, user authentication is based on an authentication token or method, voice or other biometric information. The payment transaction is completed by the payment application 180 by delivering the right payment instrument (stored or new), the right total amount, to the right processor, for the right MID, based on the right offer ID. The commerce gateway server is PCI compliant to properly guard cardholder information securely.

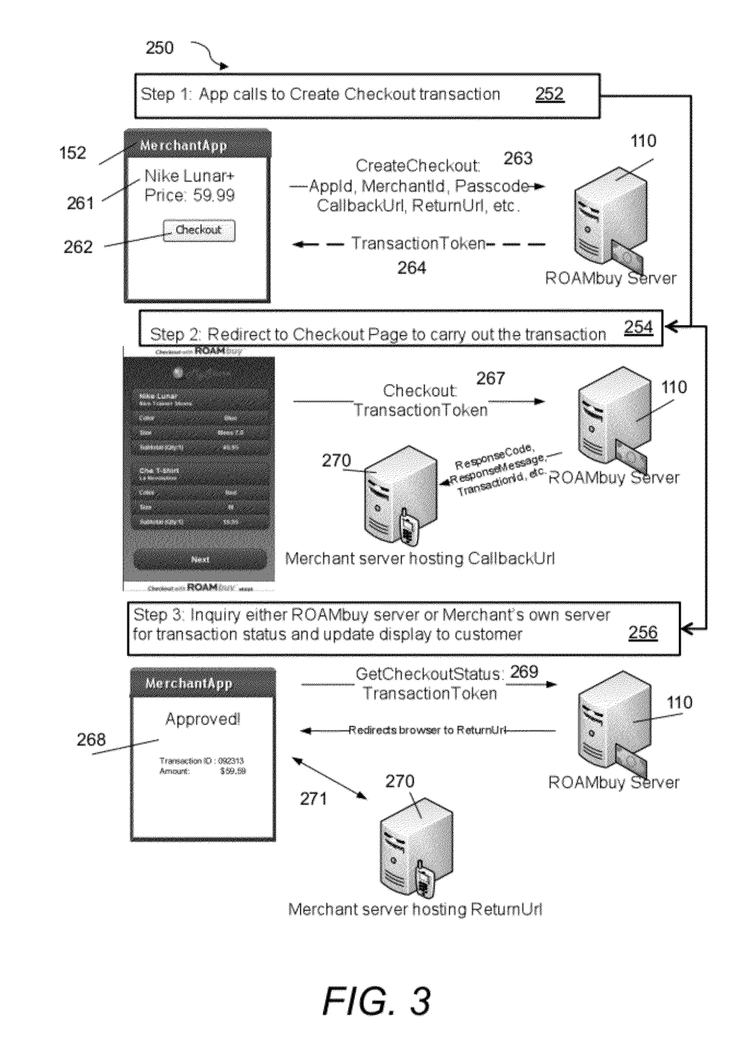

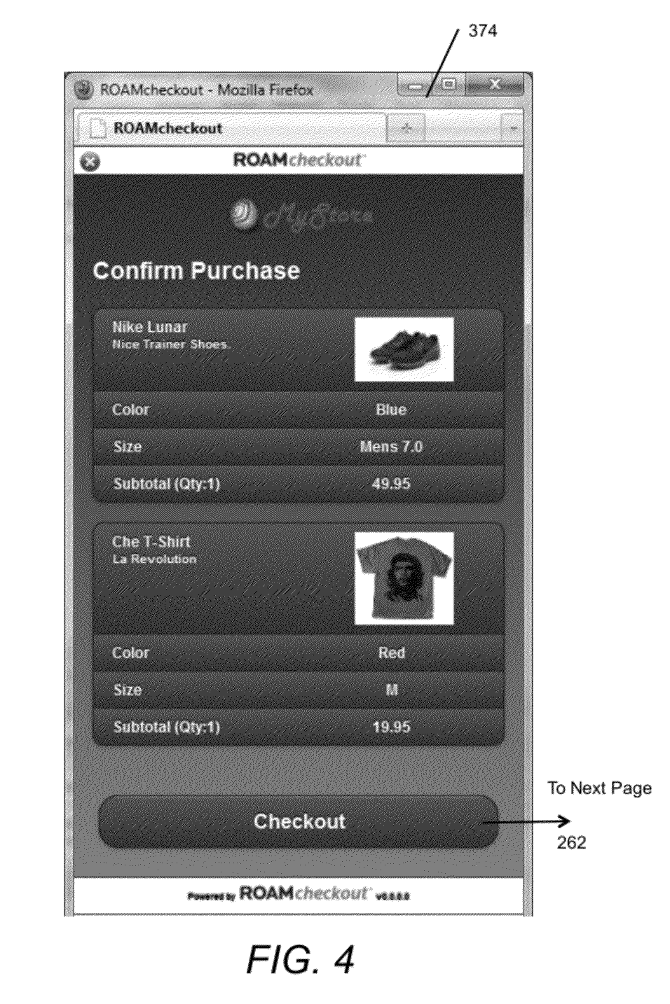

Referring back to FIG. 1A-1C, the commerce gateway server 110 further includes a checkout application 195. Checkout application 195 allows the consumers to use the commerce application 120 in order to complete the checkout process from their mobile native application “My Store” 124. Referring to FIG. 3, the checkout process 250 includes the following steps. In the first step 252, the merchant application 152 sets up the transaction data 261, and calls the checkout application 195 by selecting the checkout tab 262, shown in FIG. 4. In one example, the transaction data include product description, color, size and price, as shown in FIG. 4. In other examples, the transaction data include all level 3 credit card processing data including transaction amount, date, tax amount, customer code, merchant postal code, tax identification, merchant minority code, merchant state code, ship from postal code, destination postal code, invoice number, order number, item product code, item description, item commodity code, item quantity, item unit of measure, item extended amount, freight amount, and duty amount, among others. Checkout application 195 includes the “Create Checkout” function 263, “GetCheckoutStatus” function 269 and “Checkout” 267 function. Each merchant is issued an application ID, a merchant ID, and a merchant passcode (token). The application ID identifies the merchant calling application 152 associated with the merchant (caller). The merchant ID and merchant token belong to the merchant that provides the product and are used to identify where the payment will be transferred (payee). In most cases, the caller and payee are the same party. In cases where the “My Store” 124 carries products from more than one merchant, the application ID and merchant ID are different. The association of the merchant ID, merchant token, application ID is stored in the data in Table 171, shown in FIG. 1A. Table 171 may also include the Callback Url, Return Url, and Cancel Url associated with the merchant specified in the checkout request. The Callback Url, Return Url, and Cancel Url are hosted either in a separate merchant server 270 or the commerce gateway server 110. The “Create Checkout” request 263 includes the application ID, merchant ID, merchant token, merchant “Callback Url”, merchant “Return Url”, and the rest of the above mentioned transaction data. The “Create Checkout” request 263 also sets up and captures the location of the mobile phone. The mobile phone location is determined via a global positioning system (GPS), an Internet Protocol (IP) address, or triangulation. The “CreateCheckout” request also sets up and collects the computing device type, phone number, device identifier, international mobile equipment identity (IMEI), network service subscriber identifier or international mobile subscriber identity (IMSI). The “CreateCheckout” request also sets up and collects data for calculating tax based on address postal code. The “CreateCheckout” request also sets up and collects consumer risk level data and the checkout application 195 sends the consumer risk level data to the merchants 104, 102 via connections 520.

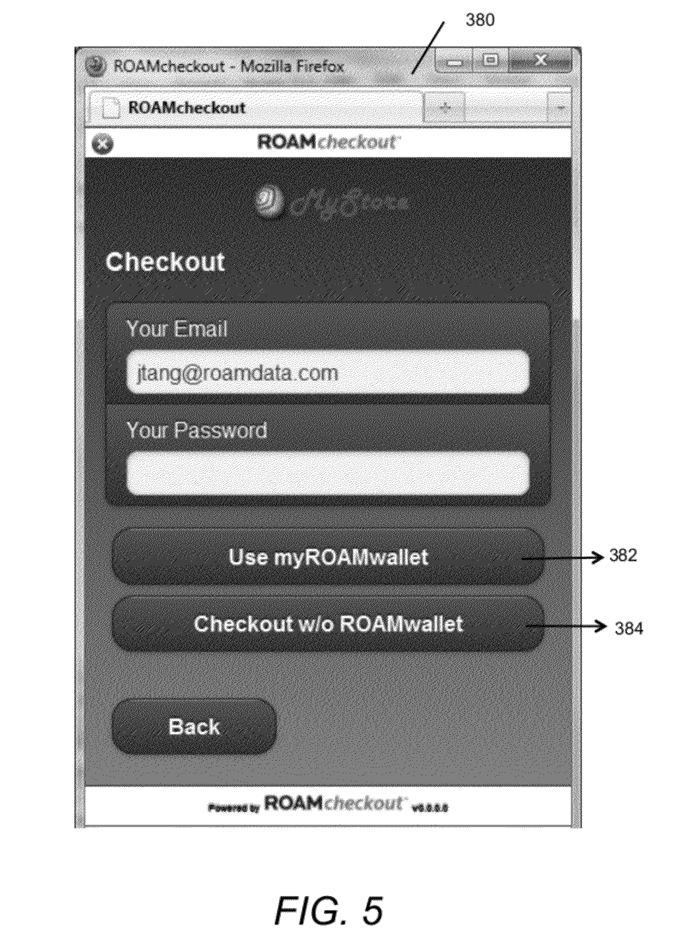

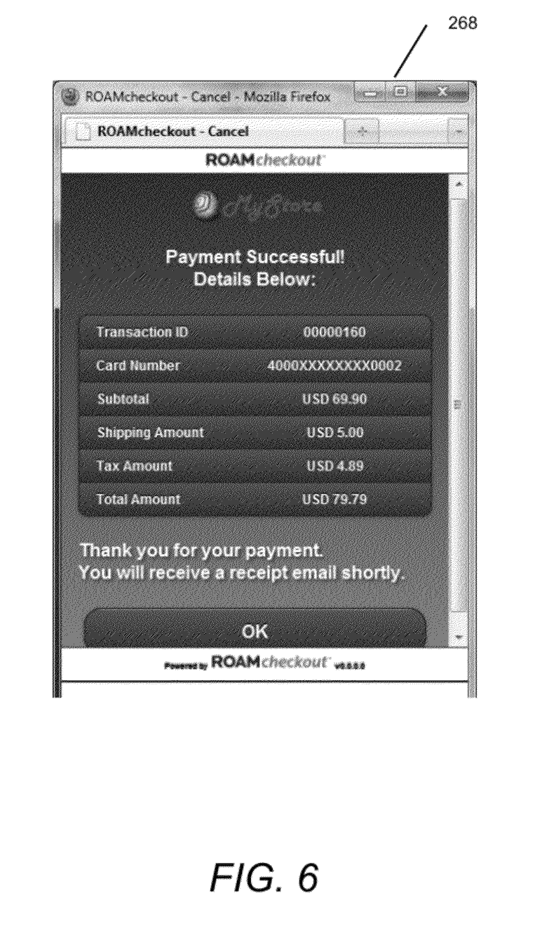

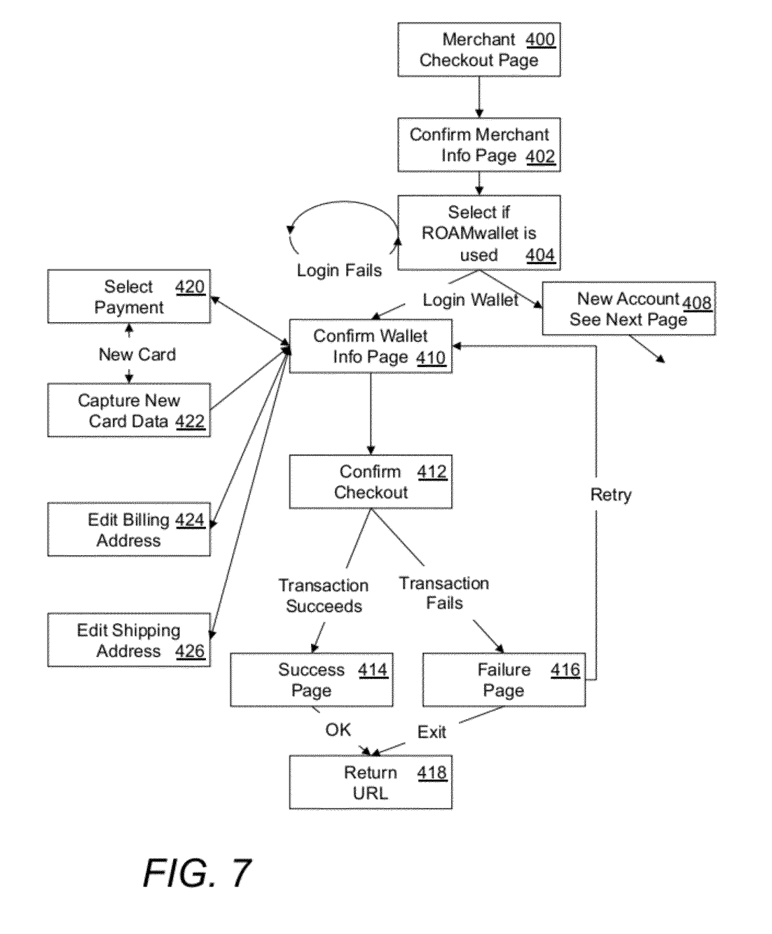

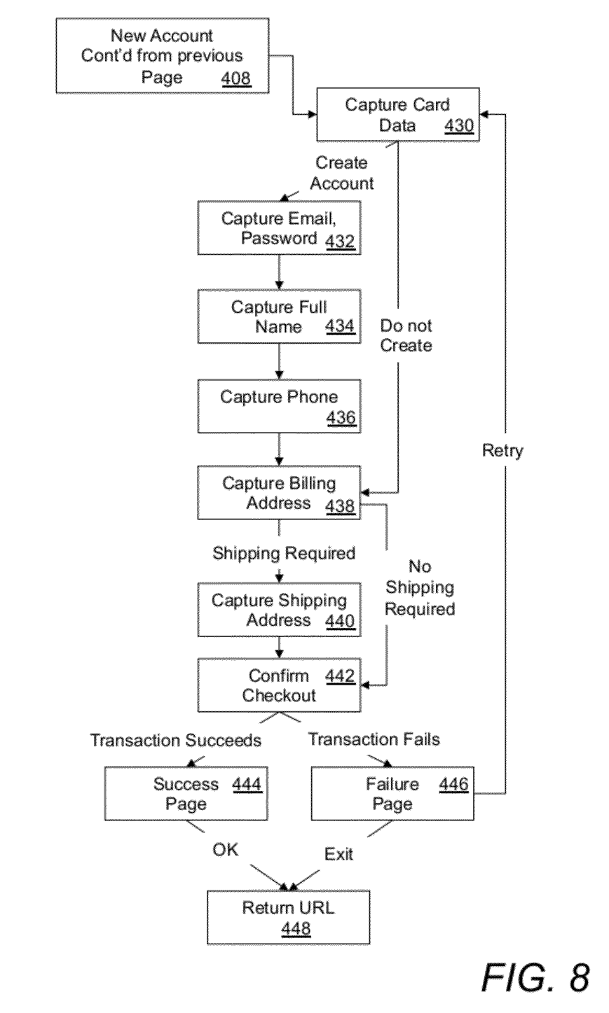

Next, the “Create Checkout” function 263 initiates a connection to the commerce gateway server 110 and starts the checkout application 195. Checkout application 195 issues a transaction token (or transaction ID) 264, which is then transmitted back to the calling application 152. In the next step 254, the “Checkout” request 267 directs the checkout application 195 to the checkout page 380, shown in FIG. 5, for carrying out the transaction. The customer ID information, password, and their payment information are retrieved either directly 384 from the consumer or from their registered user account or e-wallet 382 and then are captured by a secure webpage hosted on the commerce gateway server 110. The checkout application may also prefills checkout forms with the stored e-wallet data. The payment transaction is then executed by one of the payment processors 163, 164, 165, and the payment transaction results are posted in the merchant Callback Url specified in the “Create Checkout” request 263. In the embodiment of FIG. 3, the Callback Url is hosted in a separate merchant server 270. In the next step 256, the merchant application 152 inquiries the commerce gateway server 110 about the transaction status by issuing a “GetCheckoutStatus” request 269 for the specific transaction token, and then the transaction results are transmitted and displayed to the customer in the calling application 152. The displayed results 268 include the transaction ID, the payment amount, and a message indicating whether the transaction is approved (“Approved”, shown in FIG. 3 and FIG. 6) or not (“Declined”, or “Failed”, shown in FIG. 7), or pending (“Pending”, or “Retry”, shown in FIG. 8). Alternatively, the calling application 152 redirects the browser to the ReturnUrl hosted in the merchant server 270, as specified in the request. The flow diagram for the checkout process with an e-wallet is shown in FIG. 7 and the flow diagram for the checkout process for a new account is shown in FIG. 8. In one example, the URLs of the “CreateCheckout”, “GetcheckoutStatus” and the “Checkout” pages are as follows:

https://{root}/Roamprocess/CreateCheckout
https://{root}/Roamprocess/GetCheckoutStatus
https://{root}/Roamprocess/Checkout

The transaction parameters are entered in a name-value pair format. In other examples, transaction parameters are entered via SOAP class object, WCF data contract, XML, JSON, or other formats.

### CreateCheckout Function

The CreateCheckout function 263 is used to set up all the parameters about a transaction in the checkout process. In one example, the transaction parameters include all level 3 credit card processing parameters including transaction amount, date, tax amount, customer code, merchant postal code, tax identification, merchant minority code, merchant state code, ship from postal code, destination postal code, invoice number, order number, item product code, item description, item commodity code, item quantity, item unit of measure, item extended amount, freight amount, and duty amount, among others. A transaction token 264 is returned and this token is used to reference this transaction in all subsequent operations. A checkout can contain multiple products as long as the payment is made by a single customer to a single merchant. Also, the products must be shipped to the same shipping address.

A list of parameters is specified by using an identification index. The index starts from 0 and increases by 1 for the next item. The index does not skip over values, because items after the skipped values are ignored. A list can be nested and then a second index is provided. For example, to specify a product name, use Product_{—}0_Name for the first item and Product_{—}1_Name for the next. To specify a product attribute name of Product_{—}0, use Product_{—}0_Attribute_{—}0_Name. Tax is also calculated by the checkout application 195 based on the shipping address.

TABLE A
“CreateCheckout” request parameters include the following:

| Name | Format | Example Value | Description |
|---|---|---|---|
| Version | string | “1.0” | Provide the version of the |
| | | | protocol and data format |
| AppID | string | “00008897” | An ID assigned by Roam |
| | | | commerce window server to the |
| | | | application. Profile information |
| | | | about the application stored in |
| | | | Roam commerce window server |
| | | | can be set to configure the |
| | | | payment page, e.g. logo and |
| | | | theme, CallbackUrl, etc. |
| Passcode/AppToken | string | “p7rr4E3m” | A security code assigned by |
| | | | Roam commerce window server |
| | | | to the caller. This is used for |
| | | | validation purpose. |
| MerchantID | string | “00003772” | An ID assigned by Roam |
| | | | commerce window server to the |
| | | | payee. This is used for |
| | | | validation and identification |
| | | | purpose. |
| MerchantToken | string | “Jin834at” | A secret token assigned by |
| | | | Roam commerce window server |
| | | | to the payee. This is used for |
| | | | validation and identification |
| | | | purpose. |
| MerchantName | string | “MyStore” | Name of the payee. Information |
| | | | for customer display and |
| | | | receipt. |
| CallbackUrl | string | “http://www.mystore.com/Callback” | URL where response of the |
| | | | transaction will be sent. |
| ReturnUrl | string | “http://www.mystore.com/Return” | URL where the page will be |
| | | | redirected after the checkout. |
| TransactionType | string | “Purchase” | |
| TimeStamp | yyMMddHHmmss | | UTC timestamp of the request. |
| | | | Requests with invalid or |
| | | | expired timestamp are rejected. |
| CustomerName | string | “John Doe” | |
| CustomerEmail | string | “johndoe@gmail.com” | Can help prepopulate Roam |
| | | | commerce window server |
| | | | checkout |
| CustomerPhoneNumber | string | “123-234-5678” | The phone number of |
| | | (should include country code) | customer's originating device. |
| | | | Presence is recommended for |
| | | | mobile applications. Helps with |
| | | | security & fraud management. |
| CustomerIpAddress | string | “220.12.3.56” | The IP address of customer's |
| | | | originating device. Presence is |
| | | | recommended for online |
| | | | applications. |
| CustomerGpsLocation_Lat | double | 22.2872123 | Latitude of GPS reading in |
| | | | degrees |
| CustomerGpsLocation_Lon | double | −114.123491 | Longitude of GPS reading in |
| | | | degrees |
| MobileDeviceId | string | “309912384761311” | IMEI(for GSM)/MEID (for |
| | | | CDMA)of mobile phone |
| SubscriberId | string | “983265123234212” | IMSI of mobile phone |
| MccMnc | string | “20323” | MCC/MNC network provider |
| | 3-digit | | ID |
| | MCC + | | |
| | 2/3-digit | | |
| | MNC | | |
| RiskLevelFlag | string | “0” | Risk Level of customer as |
| | | | anticipated by the merchant that |
| | | | will affect the transaction |
| | | | approval criteria on the |
| | | | payment server |
| OfferID | string | “HJ98Q3” | This is the OfferID used in only |
| | | | ROAMstores. |
| | | | Not required for other |
| | | | applications |
| OrderId | string | “PO0297661” | Order ID used to identify the |
| | | | order under merchant's system |
| CustomData | string | “CustomerId: 1234, | Merchant application can |
| | | discount: 10” | provide any information here |
| | | | and this will be returned in the |
| | | | transaction response unaltered. |
| | | | Useful for putting information |
| | | | like invoice number, discount, |
| | | | etc. Can be in any format e.g. |
| | | | XML, but must be URL |
| | | | encoded. |
| Description | string | “My Store Purchase” | Description of the purchase for |
| | | | customer display and receipt |
| RequireShipping | bool | true/false | Defaulted to false. If set to |
| | | | false, shipping address will not |
| | | | be captured. |
| ShippingAmount | decimal | 10.00 | Default to 0.0 |
| RequreTax | bool | true/false | Defaulted to false. If set to |
| | | | false, tax amount will not be |
| | | | calculated. |
| TaxAmount | decimal | 2.00 | If provided, this amount is used |
| | | | to override Tax Amount |
| Currency | string | “USD” | Currency Code |
| Product_i_Name | string | “Nike Lunar” | Name of the product (can |
| | | | handle multiple products upon |
| | | | checkout) |
| Product_i_Description | string | “Nice trainer shoes” | Details about the product |
| Product_i_Price | decimal | 49.95 | Unit price of the product |
| | (dd.cc) | | |
| Product_i_Quantity | int | 1 | The default value is 1. |
| Product_i_ProductID | string | “MS0001” | Product ID or SKU to identify |
| | | | the product. |
| Product_i_Attribute_j_Name | string | “Color” | Attribute of the product, usually |
| Product_i_Attribute_j_Value | string | “Red” | some parameters selected at the |
| | | | merchant site. |
| | | | A attribute name must have a |
| | | | matching value |

TABLE B
“CreateCheckout” Response Parameters include the following

| | | Example | |
|---|---|---|---|
| Name | Format | Value | Description |
| Version | string | “1.0” | Provide the version of the |
| | | | protocol and data format |
| Transaction | string | “376f82a6-abb9- | A token used to identify the |
| Token | | 4081-b739- | transaction in all subsequent |
| | | aa10ca60cb48” | transactions. |
| | | | The token has a definite life- |
| | | | time and when expired, a new |
| | | | CreateCheckout must be |
| | | | called to obtain a new token. |

### GetCheckoutStatus

The GetCheckoutStatus 269 function is used to check the status of a transaction of the checkout. All returned parameters are optional depending on the availability of that piece of information. The same set of parameters is also posted to the CallBackUrl, if specified in the CreateCheckout request.

TABLE C
GetCheckoutStatus Request Parameters include the following:

| | | Example | |
|---|---|---|---|
| Name | Format | Value | Description |
| Version | string | “1.0” | Provide the version of the |
| | | | protocol and data format |
| Passcode | string | “p7rr4E3m” | A security code assigned by |
| | | | ROAMbuy to the caller. |
| | | | This is used for validation |
| | | | purpose. |
| MerchantId | string | “00003772” | An ID assigned by |
| | | | ROAMbuy to the payee. |
| | | | This is used for |
| | | | validation and |
| | | | identification purpose. |
| MerchantToken | string | “Jin834at” | A secret token assigned by |
| | | | ROAMbuy to the payee. |
| | | | This is used for validation |
| | | | and identification purpose. |
| Transaction | string | “376f82a6-abb9- | Token retuned in the |
| Token | | 4081-b739- | CreateCheckout call. |
| | | aa10ca60cb48” | |

TABLE D
GetCheckoutStatus Response Parameters include the following.

| Name | Format | Example Value | Description |
|---|---|---|---|
| Version | string | “1.0” | Provide the version of the |
| | | | protocol and data format |
| TransactionId | string | “00001234” | A transaction ID used in the |
| | | | ROAMbuy payment system |
| OrderId | string | | Order ID provided by in |
| | | | CreateCheckout |
| CustomData | string | “PO12345” | Custom data provided in |
| | | | CreateCheckout |
| TransactionDateTime | string | “110214231030” | UTC time of the transaction. |
| | yyMMddHHmmss | 2011 Feb 14 | |
| | | 23:10:30 | |
| IsApproved | boolean | true, false | Flag to indicate if operation is |
| | | | successful |
| ResponseCode | string | “9000” | Response code |
| AuthCode | sting | “MC3902” | Authcode returned by payment |
| | | | processor |
| ResponseMessage | string | “APPROVED” | Text message of the response. |
| ErrorMessage | string | “Invalid Transaction” | Text message of the error. |
| RiskLevelRef | string | “0” | Risk Level as assessed by |
| | | | ROAMcheckout for merchant's |
| | | | reference |
| CustomerLastName | string | “Doe” | Customer name as stored in |
| CustomerFirstName | string | “John” | ROAMwallet or captured |
| CustomerMiddleName | string | | during the ROAMbuy checkout |
| CustomerEmail | string | “johndoe@gmail.com” | |
| RedactedAccountNumber | string | “XXXXXXXXXXXX4456” | A redacted account number |
| | | | showing the last four digits of |
| | | | the Credit Card used in the |
| | | | payment transaction |
| Currency | string | “USD” | Currency Code |
| ChargedAmount | decimal | 12.99 | The total amount charged |
| | (dd.cc) | | |
| TaxAmount | decimal | 2.00 | Tax amount either calculated by |
| | (dd.cc) | | ROAMbuy or provided in |
| | | | CreateCheckout |
| ShippingAmount | decimal | 0.00 | Shipping amount Provided in |
| | (dd.cc) | | CreateCheckout |
| ShippingAddress1 | string | “742 Evergreen Terrace” | Shipping address captured by |
| ShippingAddress2 | string | | ROAMbuy checkout. If tax |
| ShippingCity | string | “Springfield” | calculation is required, the Tax |
| ShippingStateProvince | string | “CO” | Amount is calculated based on |
| ShippingPostalZip | string | “60001” | this address zip code for the US |
| ShippingCountry | string | “US” | |
| | 2-letter | | |
| | country | | |

The presence of all response parameters are conditional depending on the transaction result unless otherwise stated.

### Checkout Page

The Checkout request 267 is used to carry out the actual payment. The theme settings of this page including logo, colors of elements, etc, can be configured via the application profile tied to the AppID. The merchant application 152 redirects the browser control to this page by either GET or POST.

TABLE E
The Checkout Request Parameters include the following:

| Name | Format | Example Value | Description |
|---|---|---|---|
| Version | string | “1.0” | Provide the version |
| | | | of the protocol and |
| | | | data format |
| Transaction | string | “376f82a6-abb9- | Token retuned in the |
| Token | | 4081-b739- | CreateCheckout call. |
| | | aa10ca60cb48” | |

### Callback

The result of the transaction are posted back to the CallbackUrl as provided in CreateCheckout request 263. After the transaction is completed, successfully or not, the page is redirected to ReturnUrl with the following response parameters

TABLE F
Callback Response Parameters

| Name | Format | Example Value | Description |
|---|---|---|---|
| Version | string | “1.0” | Provide the version |
| | | | of the protocol and |
| | | | data format |
| Transaction | string | “376f82a6-abb9- | Token retuned in the |
| Token | | 4081-b739- | CreateCheckout call. |
| | | aa10ca60cb48” | |

At the ReturnUrl page, the merchant displays the transaction result to the customer based on the status from the callback or result from a GetCheckoutStatus call.

Example data for a “CreateCheckout” POST request
Version=1.0&AppID=100&MerchantID=100&MerchantToken=100&Passcode=pa55w0
rd
&OrderId=PO12345&CustomData=custom+data
&CallbackUrl=https%3a%2f%2fwww.mystore.com%2fresponse
&ReturnUrl=https%3a%2f%2fwww.mystore.com%2freturn
&TimeStamp=110302191604&TransactionType=Purchase
&CustomerName=John+Doe&CustomerEmail=johndoe%40gmail.com
&CustomerIpAddress=127.0.0.1&CustomerPhoneNumber=12345678
&MerchantName=MyStore&Description=MyStore+Purchase
&RequireShipping=true&ShippingAmount=10.0&RequireTax=true
&MerchantName=MyStore&Description=MyStore+Purchase
&Product_0_Name=Nike+Lunar&Product_0_Description=Nice+Trainer+Shoes.
&Product_0_Price=49.95&Product_0_Quantity=1&Product_0_ProductId=MS0010
&Product_0_Attribute_0_Name=Color&Product_0_Attribute_0_Value=Blue
&Product_0_Attribute_1_Name=Size&Product_0_Attribute_1_Value=Mens+7.0
&Product_1_Name=Che+T-Shirt&Product_1_Description=La+Revolution
&Product_1_Price=19.95&Product_1_Quantity=1&Product_1_ProductId=MS0011
&Product_1_Attribute_0_Name=Color&Product_1_Attribute_0_Value=Red
&Product_1_Attribute_1_Name=Size&Product_1_Attribute_1_Value=M

Several embodiments of the present invention have been described. Nevertheless, it will be understood that various modifications may be made without departing from the spirit and scope of the invention. Accordingly, other embodiments are within the scope of the following claims.

What is claimed is:

1. A commerce checkout and customer data capture system for merchants to deliver commerce functionalities to consumer computing devices for completing purchase and payment transactions, said system comprising:
a commerce application;
a commerce gateway server comprising a checkout application, and a secure payment application and wherein said commerce gateway server communicates with a consumer computing device via a network connection;
wherein a plurality of merchants are configured to provide product offers to said consumer computing device via said commerce application, to process purchase transactions with said checkout application, and to receive payments via said secure payment application;
wherein said checkout application provides responses to purchase transaction requests comprising “CreateCheckout” for setting up and capturing purchase transaction data and consumer relevant data, “Checkout” for calling a checkout transaction user interface, and “GetCheckoutStatus” for checking status of a checkout transaction; and
wherein said checkout application further captures additional data used to provide fulfillment capabilities, tax calculation, risk management, fraud control, and targeted marketing analytics.

2. The system of claim 1 wherein said commerce application comprises one of a native application running on said consumer computing device, a browser based application running on said consumer computing device, or a browser based application running on a merchant server or said commerce gateway server.

3. The system of claim 1 wherein said secure payment application comprises e-wallets for consumers and wherein said e-wallets store payment instrument data, fulfillment data, demographics, loyalty information, and transaction history for the consumers.

4. The system of claim 3 wherein said checkout application comprises means for prefilling checkout forms with said e-wallet data.

5. The system of claim 3 wherein the consumer fulfillment data comprise one of shipping address, billing address, email address, phone number, or loyalty relevant information.

6. The system of claim 1 wherein said commerce gateway server communicates with the consumer computing device via a checkout API and wherein said checkout API comprises one of a web service or a library object.

7. The system of claim 1 wherein said “CreateCheckout” request sets up and collects purchase transaction data comprising level 3 credit card processing data.

8. The system of claim 1 wherein said “CreateCheckout” request sets up and collects purchase transaction data comprising transaction amount, date, tax amount, customer identifier, merchant identifier, merchant security token, merchant postal code, tax identification, merchant state code, ship from postal code, destination postal code, invoice number, order number, item product identifier, item description, item commodity code, item quantity, item unit of measure, freight amount, and duty amount.

9. The system of claim 1 wherein said “CreateCheckout” request sets up and collects purchase transaction data comprising consumer computing device location, and wherein said consumer computing device location is determined via at least one of a GPS, an IP address, or triangulation.

10. The system of claim 1 wherein said “CreateCheckout” request sets up and collects purchase transaction data comprising at least one of consumer computing device type, phone number, device identifier, international mobile equipment identity (IMEI), network service subscriber identifier, or international mobile subscriber identity (IMSI).

11. The system of claim 1 wherein said “CreateCheckout” request sets up and collects purchase transaction data comprising data for calculating tax based on address postal code.

12. The system of claim 1 wherein said “CreateCheckout” request sets up and collects purchase transaction data comprising consumer risk level data.

13. The system of claim 12 wherein said checkout application sends said consumer risk level data to said merchants.

14. The system of claim 1 wherein said purchase transaction data comprise merchant and application identification data and wherein said merchant identification data comprise a merchant identifier and a merchant security token and wherein said application identification data comprise an application identifier, and an application security token.

15. The system of claim 1 wherein said purchase transaction data comprise transaction flow control parameters and wherein said transaction flow control parameters comprise one of merchant CallbackUrl, merchant ReturnUrl, or merchant CancelUrl.

16. The system of claim 1 wherein said checkout application responds to said “CreateCheckout” request by sending a transaction identifier and wherein said transaction identifier is used in all subsequent checkout operations.

17. The system of claim 16 wherein said “Checkout” request directs the checkout application to carry out a purchase transaction identified by a specific transaction identifier.

18. The system of claim 16 wherein said “GetCheckoutStatus” request directs the checkout application to provide checkout status information for a purchase transaction identified by a specific transaction identifier, to display the checkout status information in the consumer computing device, and to provide consumer risk level data and fulfillment data back to the merchant.

19. The system of claim 1 wherein said consumer computing device comprises one of mobile phone, PDA, payment module, portable computer, personal computer, set-top box, netbook, tablets, iPad, electronic reader, or an internet appliance.

20. A method for merchants to deliver commerce functionalities to consumer computing devices for completing purchase and payment transactions, said method comprising:
providing a commerce application;
providing a commerce gateway server comprising a checkout application, and a secure payment application, and wherein said commerce gateway server communicates with a consumer computing device via a network connection;
wherein a plurality of merchants are configured to provide product offers to said consumer computing device via said commerce application, to process purchase transactions with said checkout application and to receive payments via said secure payment application;
wherein said checkout application provides responses to purchase transaction requests comprising “CreateCheckout” for setting up and capturing purchase transaction data, and consumer relevant data, “Checkout” for calling a checkout transaction user interface, and “GetCheckoutStatus” for checking status of a checkout transaction; and
wherein said checkout application further captures additional data used to provide fulfillment capabilities, tax calculation, risk management, fraud control, and targeted marketing analytics.

21. The method of claim 20 wherein said commerce application comprises one of a native application running on said consumer computing device, a browser based application running on said consumer computing device, or a browser based application running on a merchant server or said commerce gateway server.

22. The method of claim 20 wherein said secure payment application comprises e-wallets for consumers, and wherein said e-wallets store payment instrument data, fulfillment data, demographics, loyalty information, and transaction history for the consumers.

23. The method of claim 22 further comprising prefilling checkout forms with said e-wallet data.

24. The method of claim 22 wherein the consumer fulfillment data comprise one of shipping address, billing address, email address, phone number, or loyalty relevant information.

25. The method of claim 20 wherein said commerce gateway server communicates with the consumer computing device via a checkout API and wherein said checkout API comprises one of a web service or a library object.

26. The method of claim 20 wherein said “CreateCheckout” request sets up and collects purchase transaction data comprising level 3 credit card processing data.

27. The method of claim 20 wherein said “CreateCheckout” request sets up and collects purchase transaction data comprising transaction amount, date, tax amount, customer identifier, merchant identifier, merchant security token, merchant postal code, tax identification, merchant state code, ship from postal code, destination postal code, invoice number, order number, item product identifier, item description, item commodity code, item quantity, item unit of measure, freight amount, and duty amount.

28. The method of claim 20 wherein said “CreateCheckout” request sets up and collects purchase transaction data comprising consumer computing device location, and wherein said consumer computing device location is determined via at least one of a GPS, an IP address, or triangulation.

29. The method of claim 20 wherein said “CreateCheckout” request sets up and collects purchase transaction data comprising at least one of consumer computing device type, phone number, device identifier, international mobile equipment identity (IMEI), network service subscriber identifier, or international mobile subscriber identity (IMSI).

30. The method of claim 20 wherein said “CreateCheckout” request sets up and collects purchase transaction data comprising data for calculating tax based on address postal code.

31. The method of claim 20 wherein said “CreateCheckout” request sets up and collects purchase transaction data comprising consumer risk level data.

32. The method of claim 31 further comprising sending said consumer risk level data to said merchants.

33. The method of claim 20 wherein said purchase transaction data comprise merchant and application identification data, and wherein said merchant identification data comprise a merchant identifier and a merchant security token, and wherein said application identification data comprise an application identifier and an application security token.

34. The method of claim 20 wherein said purchase transaction data comprise transaction flow control parameters and wherein said transaction flow control parameters comprise one of merchant CallbackUrl, merchant ReturnUrl, or merchant CancelUrl.

35. The method of claim 20 wherein said checkout application responds to said “CreateCheckout” request by sending a transaction identifier, and wherein said transaction identifier is used in all subsequent checkout operations.

36. The method of claim 35 wherein said “Checkout” request directs the checkout application to carry out a purchase transaction identified by a specific transaction identifier.

37. The method of claim 35 wherein said “GetCheckoutStatus” request directs the checkout application to provide checkout status information for a purchase transaction identified by a specific transaction identifier, to display the checkout status information in the consumer computing device, and to provide consumer risk level data and fulfillment data back to the merchant.

38. The method of claim 20 wherein said consumer computing device comprises one of mobile phone, PDA, payment module, portable computer, personal computer, set-top box, netbook, tablets, iPad, electronic reader, or an internet appliance.
